(19) United States
(12) Patent Application Publication
(10) Pub. No.: US 2014/0285904 A1
(43) Pub. Date: Sep. 25, 2014

(54) LENS BARREL AND IMAGING DEVICE EQUIPPED WITH SAME

(71) Applicant: Panasonic Corporation, Osaka (JP)

(72) Inventor: Kenji IKEO, Osaka (JP)

(73) Assignee: Panasonic Corporation, Osaka (JP)

(21) Appl. No.: 14/218,980

(22) Filed: Mar. 19, 2014

(30) Foreign Application Priority Data
Mar. 21, 2013 (JP) 2013-057612
Feb. 17, 2014 (JP) 2014-027419

(51) Int. Cl. G02B 7/10

(52) U.S. Cl. CPC G02B 7/102
USPC 359/696

(57) ABSTRACT

There is provided a lens barrel with a high degree of design latitude, with which an index display portion can be driven regardless of the amount of drive of the lens. This lens barrel comprises a first driver first driver that moves a lens frame in a rectilinear direction, a position sensor that senses the position of the lens frame, a computer that computes an optical characteristic on the basis of the position of the lens frame sensed by the position sensor, a display portion that displays the optical characteristic, and a second driver that drives the display portion on the basis of the computation result of the computer.

### CROSS-REFERENCE TO RELATED APPLICATIONS

This application claims priority to Japanese Patent Applications No. 2013-057612 filed on Mar. 21, 2013 and No. 2014-027419 filed on Feb. 17, 2014. The entire disclosure of Japanese Patent Applications No. 2013-057612 and No. 2014-027419 are hereby incorporated herein by reference.

### BACKGROUND

### Technical Field

The present invention relates to a lens barrel for an interchangeable lens type of camera, and to an imaging device equipped with this lens barrel.

Patent Literature 1 (Japanese Laid-Open Patent Application 2006-171443) discloses a technique in which a lens drive motor incorporated into the lens frames of a zoom lens group and a focus lens group, and a zoom ring that can be rotated by a DC motor are electrically connected. Patent Literature 1 also discloses that focal distance graduations corresponding to the position of the zoom lens group are printed or engraved around the zoom ring so that they can be read.

### SUMMARY

This disclosure provides a lens barrel with a high degree of design latitude, with which an index display portion can be driven regardless of the amount of drive of the lens.

The lens barrel disclosed herein comprises a lens frame that holds a lens, a first driver that moves the lens frame in a rectilinear direction, a position sensor that senses the position of the lens frame, a computer that computes an optical characteristic on the basis of the position of the lens frame sensed by the position sensor, a display portion that displays the optical characteristic, and a second driver that drives the display portion on the basis of the computation result of the computer.

Also, with the lens barrel disclosed herein, it is preferable if the ratio between the amount of drive of the first driver and the amount of drive of the second driver varies with the position of the lens frame.

The lens barrel disclosed herein comprises a cam frame that is rotationally driven to move a lens frame holding a lens, in the optical axis direction, a first driver that moves the cam frame in a rotational direction, a position sensor that senses the position of the cam frame in the rotational direction, a computer that computes an optical characteristic on the basis of the position of the cam frame sensed by the position sensor, and a second driver that drives a display portion on the basis of the computation result of the computer.

Also, with the lens barrel disclosed herein, it is preferable if the ratio between the amount of drive of the first driver and the amount of drive of the second driver varies with the position of the cam frame.

With this disclosure, a lens barrel is provided that has a high degree of design latitude, and with which an index display portion can be driven regardless of the amount of drive of the lens.

### BRIEF DESCRIPTION OF DRAWINGS

FIG. 1 is a simplified oblique view of an interchangeable lens type of camera to which is mounted the lens barrel pertaining to Embodiment 1;

FIG. 2 is a simplified cross section of the interior of the lens barrel in FIG. 1;

FIG. 3 is a simplified diagram of the functional configuration of the lens barrel in FIG. 1;

FIG. 4A is a flowchart illustrating the flow of processing when the subject distance is displayed on an index ring of the lens barrel in FIG. 1, FIG. 4B is a flowchart illustrating the flow of operation of the index ring during wobbling of the lens barrel in FIG. 1, and FIG. 4C is a detail flowchart of the wobbling operation with the lens barrel in FIG. 1;

FIG. 5A is a simplified diagram of the index ring representing an optical characteristic with a conventional lens barrel, and FIG. 5B is a simplified diagram of the index ring representing an optical characteristic with the lens barrel in FIG. 1;

FIG. 6A is a simplified graph of the focus path of the zoom lens in a conventional lens barrel, and FIG. 6B is a simplified graph of the focus path of the zoom lens in the lens barrel in FIG. 1;

FIG. 7 is a flowchart illustrating the flow of processing when the focal distance is displayed on the index ring of the lens barrel pertaining to Embodiment 2;

FIG. 8 is a simplified cross section of the interior of the lens barrel pertaining to Embodiment 3; and

FIG. 9 is a simplified diagram of the functional configuration of the lens barrel pertaining to another embodiment.

### DETAILED DESCRIPTION OF THE PREFERRED EMBODIMENTS

Embodiments will now be described in detail through reference to the drawings as needed. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The inventor has provided the appended drawings and the following description so that a person skilled in the art might fully understand this disclosure, but does not intend for these to limit what is discussed in the patent claims.

### Embodiment 1

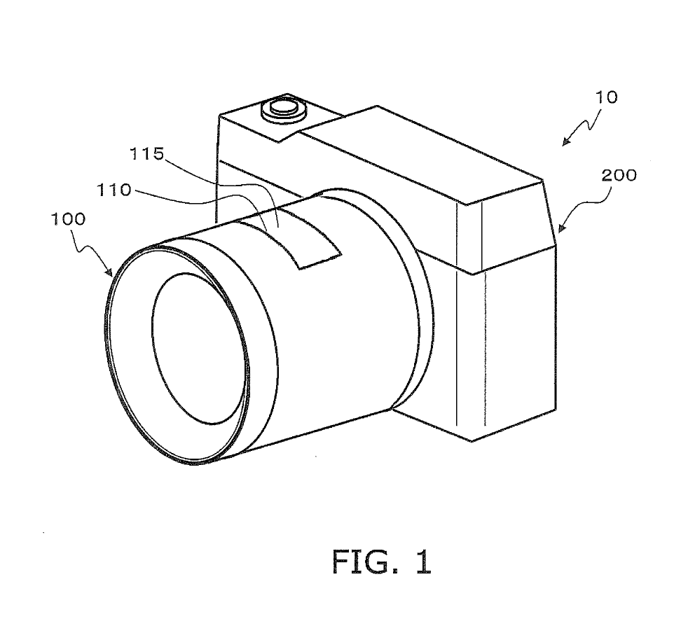

The configuration of an interchangeable lens (lens barrel) 100 pertaining to Embodiment 1 will now be described through reference to FIGS. 1 to 6.

1. Configuration

FIG. 1 is a simplified oblique view of an imaging device 10 to which is mounted the interchangeable lens 100 of this embodiment.

The imaging device 10 comprises a camera body 200 and the interchangeable lens 100 (an example of a lens barrel).

The interchangeable lens 100 is mounted to the camera body 200 by connecting a lens mount (not shown) of the interchangeable lens 100 to a lens mount (not shown) of the camera body 200. The interchangeable lens 100 also has an index ring (display portion) 110 that displays an optical characteristic of the camera. The index ring 110 is an example of a display portion that displays an optical characteristic.

The index ring 110 displays an optical characteristic such as the subject distance, the focal distance, or the imaging magnification. The subject distance is the distance from the imaging plane to the subject that is in focus, depending on the position of a focus lens (lens 101).

More specifically, the index ring 110 is provided to the outer peripheral face of the interchangeable lens 100 in order to read an optical characteristic by lining up an index or numerical value printed or engraved around the outside of a stationary ring or a turn ring of the interchangeable lens 100, with an index or numerical value that moves when the ring is turned.

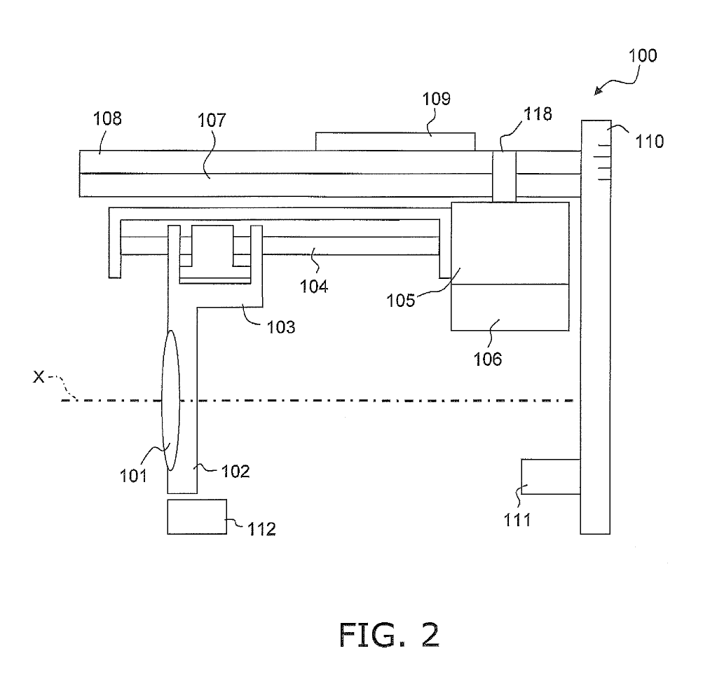

FIG. 2 is a simplified cross section of the interchangeable lens 100.

The interchangeable lens 100 comprises the lens 101, a lens frame 102, a rack 103, a shaft 104, a focus motor (first driver) 105, a motor support frame 106, a rectilinear frame 107, a cam frame 108, a zoom ring 109, the index ring 110, an index ring motor (second driver) 111, and a lens position sensor (position sensor) 112.

The lens 101 is a focus lens. The lens 101 is supported by the lens frame 102.

The focus motor 105 in this embodiment is a stepping motor. The focus motor 105 is not limited to being a stepping motor, however, and may be any kind of actuator.

The motor support frame 106 supports the focus motor 105. The motor support frame 106 also has a convex portion 118 that protrudes in a direction perpendicular to the optical axis X. The convex portion 118 mates with a rectilinear groove in the rectilinear frame 107 and a cam groove in the cam frame 108.

The shaft 104 is attached to the focus motor 105. The shaft 104 rotates under drive by the focus motor 105. Spiral thread grooves are formed in the shaft 104.

Teeth that mesh with the thread grooves of the shaft 104 are formed on the rack 103, and the teeth of the rack 103 mesh with the thread grooves of the shaft 104. The rack 103 supports the lens frame 102. Furthermore, the rack 103 converts the rotational drive of the shaft 104 into rectilinear drive of the lens frame 102. This allows the lens frame 102 to move in the optical axis X direction.

The lens position sensor 112 senses the position of the lens frame 102 in the lens barrel in a rectilinear direction of the optical axis X. More specifically, the lens position sensor 112 is used to sense the home point of the lens 101 when the power is turned on to the imaging device 10. After sensing the home position of the lens 101, the lens 101 is driven by the focus motor 105 to a specific position. The position of the lens 101 after this drive is sensed on the basis of the amount of drive of the lens frame 102 by the focus motor 105, using the home position as a reference.

In this embodiment, the lens position sensor 112 does not constantly sense the position of the lens 101. Also, in this embodiment, the sensing by the lens position sensor 112 is performed only during sensing of the home point, but the configuration may be such that the position of the lens 101 is constantly sensed.

The rectilinear frame 107 has a rectilinear groove extending in a direction parallel to the optical axis X direction.

The cam frame 108 has a cam groove, and is disposed on the outer peripheral side of the rectilinear frame 107 so that it can rotate around the rectilinear frame 107.

The convex portion 118 of the motor support frame 106 mates with the groove of the rectilinear frame 107 and the cam groove of the cam frame 108.

Consequently, when the cam frame 108 rotates, the position at which the motor support frame 106 is supported changes in the optical axis direction along the rectilinear groove formed in the rectilinear frame 107.

The zoom ring 109 is mechanically linked to the cam frame 108 by another member (not shown), and is turned by manual operation. When the zoom ring 109 is turned, a zoom lens group (not shown) is driven in the optical axis direction.

The index ring motor 111 is a stepping motor, and rotationally drives the index ring 110 on the basis of the drive amount of the lens frame 102 sensed by the lens position sensor 112.

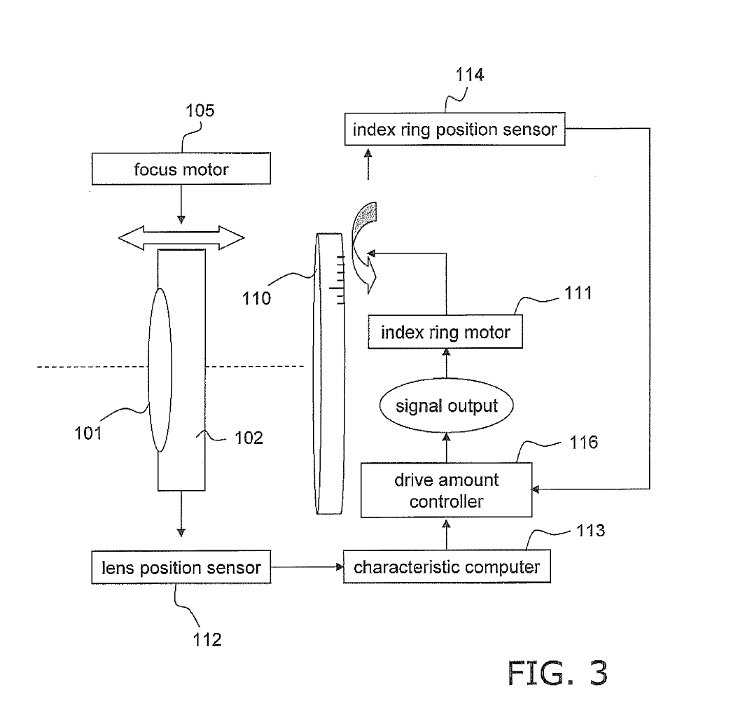

FIG. 3 is a simplified diagram of the functional configuration of the lens barrel 100 in this embodiment.

The lens frame 102 is driven in the optical axis direction by the focus motor 105. The position of the lens frame 102 that is driven in the optical axis direction is sensed by the lens position sensor 112.

The subject distance is calculated by a characteristic computer 113 on the basis of the position of the lens frame 102 and other necessary information (such as information about the focal distance from the zoom lens).

An index ring position sensor 114 senses the position of the index ring 110. A drive amount controller 116 calculates the drive amount of the index ring motor 111 on the basis of calculation result of the characteristic computer 113 and the sensing result of the index ring position sensor 114, and outputs a drive signal corresponding to the drive amount thus found to the index ring motor 111.

With the interchangeable lens 100 in this embodiment, in the above-mentioned operation, the ratio between the drive amount of the focus motor 105 and the drive amount of the index ring motor is varied as needed according to the position of the lens frame 102, that is, the focus position.

2. Processing

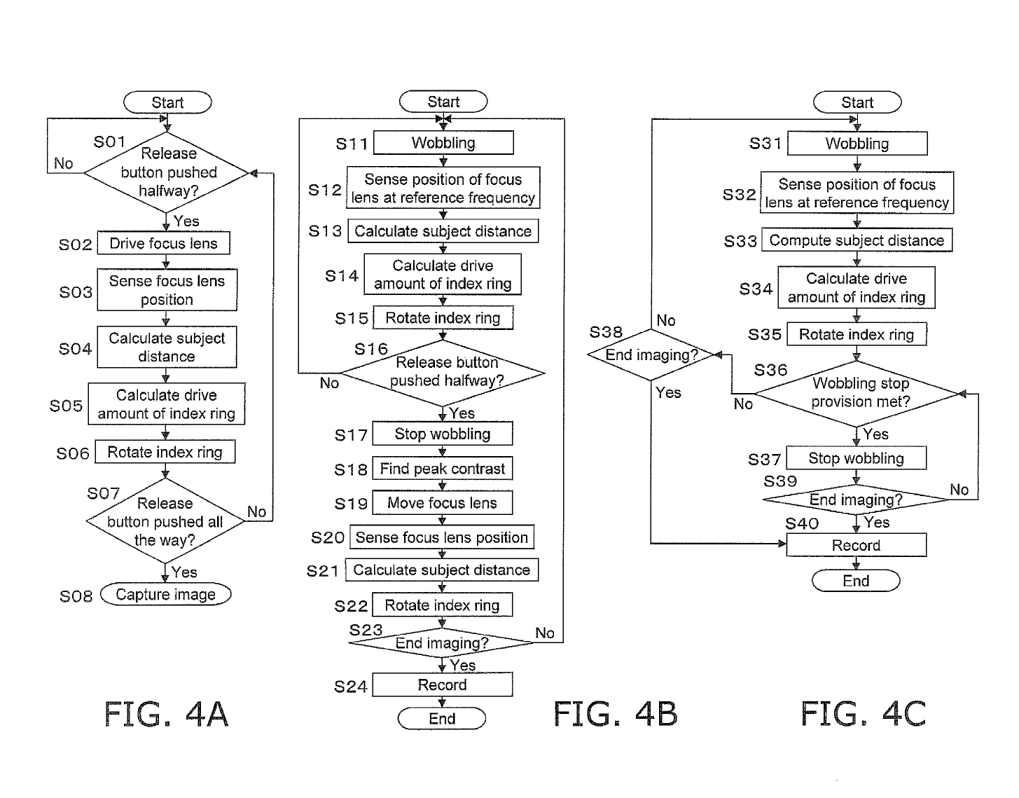

FIG. 4A is a flowchart of the flow of processing for index ring drive in the capture of a still picture.

First, the user presses the release button halfway down to put the subject in focus (S01).

Next, the lens 101 is scan driven in response to the release button being pushed halfway down (S02). This “scan drive” refers to moving the lens 101 to find the peak of contrast, and is called the hill-climbing method.

Next, during scan drive, the position of the lens 101 is sensed by the lens position sensor 112 (S03).

Next, the subject distance is calculated from the position of the lens 101 thus sensed (S04).

Next, the drive amount of the index ring is calculated on the basis of the subject distance by the drive amount controller 116 S05.

Next, a drive signal corresponding to the change in the subject distance is outputted to the index ring motor 111.

Next, the index ring 110 is rotationally driven (S06) so that the subject distance is displayed.

Here, imaging is executed if the release button has been pushed down all the way (Yes in S07). On the other hand, processing returns to S01 if the release button has not been pushed down all the way.

FIG. 4B is a flowchart illustrating the flow of processing when the subject distance is displayed on the index ring 110 in moving picture capture.

First, when imaging with the imaging device 10 is commenced, the imaging device 10 performs a wobbling operation (S11).

The lens 101 is driven back and forth in the optical axis direction in short movements at a specific frequency by this wobbling operation.

Next, the lens position sensor 112 senses the position of the lens 101 at a reference frequency (such as 60 Hz) interval (S12).

The reference frequency is a frequency used to sense the lens position, which is used when rotating the index ring. The reference frequency is preferably equal to or lower than the predetermined frequency for wobbling. Also, the reference frequency can be used for sensing the lens position at a frequency interval that is at least the same as or wider than the predetermined frequency for wobbling.

Next, the characteristic computer 113 calculates the subject distance on the basis of position information sensed by the lens position sensor 112 (S13). More specifically, after the home position is aligned, the subject distance is calculated from the position calculated on the basis of the amount of deviation from the home point.

Next, and drive amount of the index ring is calculated from the subject distance calculated in S13 and from index ring position information obtained from the index ring position sensor 114 (S14).

Next, the drive amount controller 116 outputs a drive signal corresponding to the drive amount, and rotationally drives the index ring 110 (S15).

Next, a body-side microprocessor (not shown) detects whether or not the user has pushed the release button halfway down. If it is determined that the button has been pushed halfway down (Yes in S16), the wobbling is stopped (S17). If it is determined that the button has not been pushed halfway down (No in S16), the wobbling is continued (return to S11).

Next, after the wobbling has stopped (S17), the lens 101 is scan driven (S18).

Next, during scan drive, the position of the lens 101 is sensed (S20).

Next, the subject distance is calculated from the sensed position of the lens 101 (S21).

Next, a drive signal corresponding to movement by the subject distance is outputted to the index ring motor 111, and the index ring 110 is rotationally driven (S22).

Next, a body-side microprocessor (not shown) detects whether or not the user has performed an operation to end imaging. If it is determined that such an operation has been performed (Yes in S23), the recording of the image is concluded (S24). On the other hand, if it is determined that no such operation has been performed (No in S23), wobbling is continued (return to S11).

FIG. 4 is a flowchart showing the wobbling operation in detail.

First, when the capture of a moving picture is commenced, wobbling begins at the imaging device 10 (S31).

Next, the position of the lens 101 is sensed at a specific period during the wobbling operation, that is, at the reference frequency (S32). The interval of this sensing is, as mentioned above, either the same as or wider than the frequency of the wobbling.

Next, the characteristic computer 113 calculates the subject distance on the basis of the sensed position of the lens 101 (S33). The calculation method used here is as discussed above.

Next, the drive amount of the index ring is calculated on the basis of the subject distance calculated in S33 and the index ring position information sensed by the index ring position sensor 114 (S34).

Next, the drive amount controller 116 outputs a drive signal corresponding to the drive amount of the index ring, and the index ring 110 is rotationally driven (S35).

Next, a body-side microprocessor (not shown) decides whether or not the number of wobbles has met a specific criterion (wobbling stop provision) (S36).

If the wobbling stop provision is met (Yes in S36), there is no need for wobbling, so the wobbling operation is stopped (S37), and it is decided whether or not to end imaging (S39). The “wobbling stop provision” refers to a case in which it is decided that the subject is not moving, in a state in which the focus position is at its peak.

On the other hand, if the wobbling provision is not met (No in S36), it is decided whether or not to end the imaging (S39).

If the imaging is not ended, but continued (No in S39), the flow returns to the start, and the above steps are repeated while wobbling continues. If the imaging is ended, however (Yes in S39), the image is recorded and the process ended (S40).

3. Effects

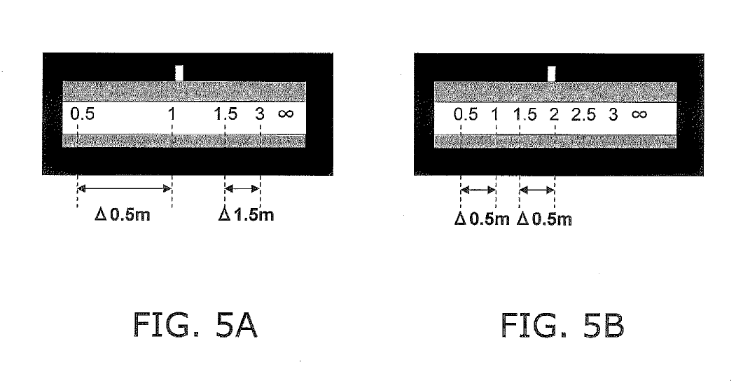

FIG. 5A is a simplified diagram of the graduation layout on a conventional index ring. FIG. 5B is a simplified diagram of the graduation layout on the index ring 110 in this embodiment.

With the conventional index ring, the lens frame and the drive were linked, so the positional relation between the subject distance and the index ring was fixed. Specifically, the ratio between the drive amount of the lens frame and the drive amount of the index ring was constant, regardless of the position of the lens frame.

Accordingly, as shown in FIG. 5A, the subject distance and the intervals of the displayed subject distance graduations are not in a fixed relation. Specifically, with the conventional configuration, as shown in FIG. 5A, the subject distance changed greatly with a small graduation interval, or the subject distance only changed a little despite a wide graduation interval, and this made it harder for the user to intuitively grasp the changes, and made the camera less convenient to use. More specifically, with the index ring shown in FIG. 5A, the 0.5-meter interval for subject distance from 0.5 m to 1 m was larger than the 1.5-meter interval from 1.5 m to 3 m.

With the interchangeable lens 100 in this embodiment, on the other hand, the index ring motor 111 used for rotationally driving the index ring 110 is provided separately from the focus motor 105 used for driving the lens 101, and the drive amount calculated by the characteristic computer 113 is transmitted as a signal to the index ring motor 111.

Specifically, with the interchangeable lens 100 in this embodiment, the index ring motor 111 is provided separately, rather than using the focus motor 105 as the drive source for rotationally driving the index ring 110.

Consequently, since the drive of the index ring motor 111 is not limited by the drive of the focus motor 105, this affords greater latitude in designing the interchangeable lens 100, such as the display on the index ring motor 111.

Furthermore, in this embodiment, the ratio between the drive amount of the focus motor 105 and the drive amount of the index ring motor 111 varies with the position of the lens frame 102.

Consequently, the index ring 110 shown in FIG. 5B can be realized. More specifically, as shown in FIG. 5B, the subject distance can be displayed in uniform intervals of 0.5 m from a distance of 0.5 m to 3 m. In other words, the intervals of the distance graduations to be displayed on the index ring 110 can be freely adjusted at the design stage.

This makes it possible to display the amount of change in the subject distance with distance graduations laid out at regular intervals. Furthermore, it is also possible to give a subject distance display that is more detailed than in other areas depending on the subject distance area (such as near the maximum zoom-in position).

Also, separately configuring the focus motor 105 used for driving the focus lens and the index ring 110 used for driving the index ring means that there will be fewer restrictions on the optical design.

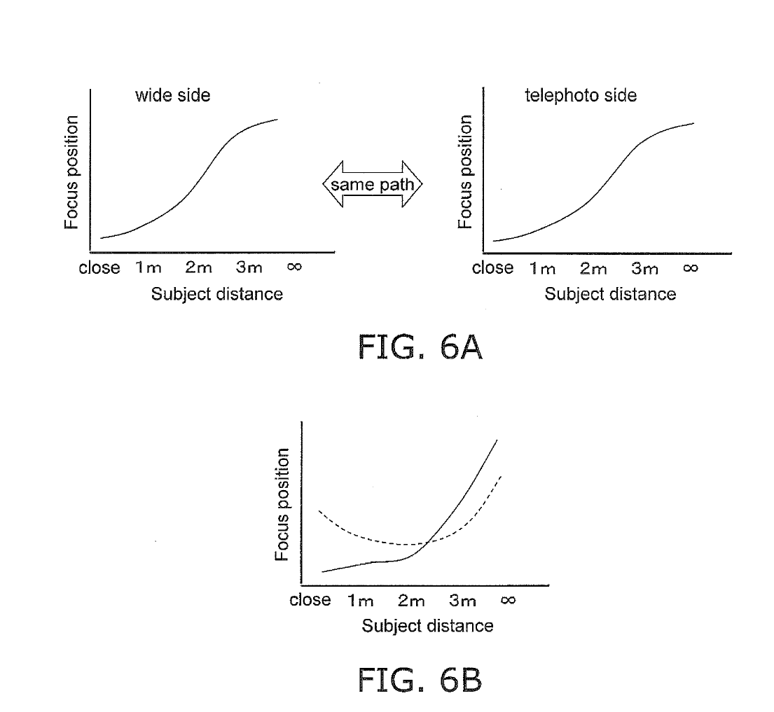

This will now described in detail through reference to FIGS. 6A and 6B.

FIG. 6A is a graph of the focus path of a conventional zoom lens. FIG. 6B is a graph of the focus path of the zoom lens in this embodiment.

Conventionally, since the lens frame and the index ring were linked in their drive, it was necessary for the drive path of the lens frame with respect to the motor holding frame (the subject distance with respect to the lens frame position) to be kept constant over the entire zoom range, namely, from wide angle to telephoto. Accordingly, the design matched the wide angle side to the telephoto side on which the amount of focus movement was larger.

Consequently, the wide angle side was driven at a movement amount that was larger than necessary, so focusing time ended up taking longer than necessary.

Meanwhile, with the interchangeable lens 100 in this embodiment, because of the above configuration, the drive path of the lens frame 102 with respect to the motor support frame 106 (the subject distance with respect to the lens frame position) does not have to be kept constant for every zoom position, as shown in FIG. 6B.

The solid and dotted lines in the graph shown in FIG. 6B represent the wide and telephoto sides, respectively, but may be switched around.

Consequently, design is possible at the optimal focus drive amount on the wide angle side, and the focusing time can be shortened.

4. Conclusion

As discussed above, the interchangeable lens 100 in this embodiment comprises the lens frame 102, the focus motor 105, the lens position sensor 112, the characteristic computer 113, the index ring 110, and the index ring motor 111.

The focus motor 105 moves the lens frame 102 in a rectilinear direction along the optical axis.

The lens position sensor 112 senses the position of the lens frame 102.

The characteristic computer 113 computes an optical characteristic (the subject distance in this embodiment) on the basis of the position of the lens frame 102 sensed by the lens position sensor 112.

The index ring 110 displays the optical characteristic on a display portion 115 on the basis of the drive amount calculated by the characteristic computer 113.

The index ring motor 111 drives the index ring 110 on the basis of the computation result of the characteristic computer 113.

Furthermore, the ratio between the drive amount generated by the focus motor 105 and the drive amount of the index ring motor 111 varies with the position of the lens frame 102.

This configuration allows the graduation display on the index ring 110 to be set as desired, which means that a lens barrel can be provided that affords greater design latitude than in the past.

### Embodiment 2

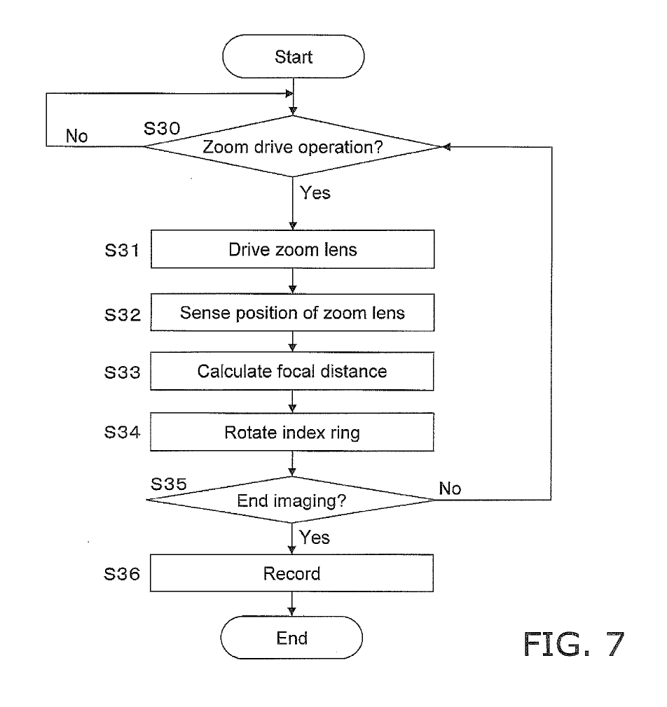

FIG. 7 shows the flow of the index ring drive processing when the optical characteristic displayed on the index ring is the focal distance. In the following description, the processing that is the same as in Embodiment 1 will be omitted, and the description will focus on the part of the processing that is different.

More specifically, in Embodiment 1 above, the subject distance was calculated as the optical characteristic calculated by the characteristic computer 113 on the basis of the position of the lens frame 102 sensed by the lens position sensor 112, but in this embodiment, what is calculated is the focal distance.

First, with the power to the camera turned on, if the user performs a zoom drive operation (Yes in S30), the zoom lens is driven according to this zoom drive operation (S31).

Next, while the zoom lens is being driven, the position of the zoom lens is sensed (S32), and the focal distance is calculated on the basis of the sensed zoom lens position (S33).

Next, the index ring is rotated so that the focal distance calculated in S33 will be displayed on the display portion 115 of the index ring 110 (S34).

Next, if imaging is ended (Yes in S35), the image is recorded (S36) and the processing ended. On the other hand, if the imaging is not ended, but continued (No in S35), the flow returns to the step of deciding about zoom drive operation (S30).

Just as in Embodiment 1 above, this configuration allows the graduation display on the index ring 110 to be set as desired, which means that a lens barrel can be provided that affords greater design latitude than in the past.

### Embodiment 3

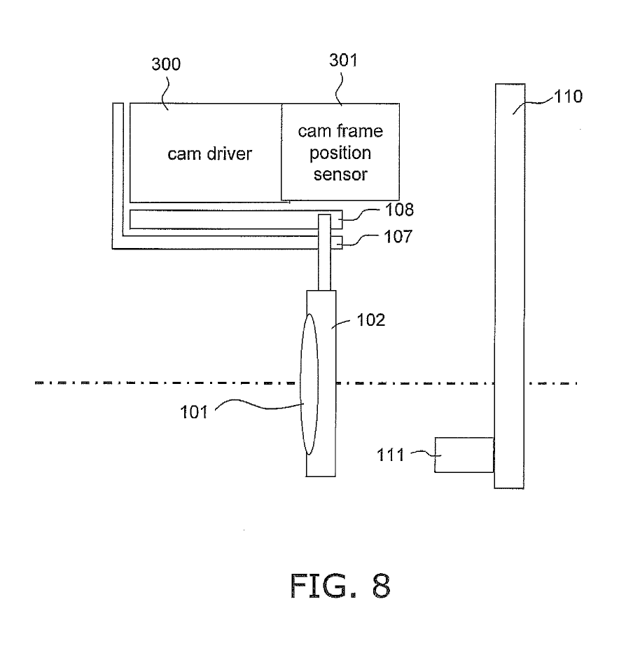

FIG. 8 is a simplified cross section of the interchangeable lens 100 in Embodiment 3.

In Embodiments 1 and 2 above, the position of the lens 101 (lens frame 102) was sensed, but this embodiment is different in that the position of the cam frame 108 is sensed. The following description will focus on the part of the configuration that is different.

The interchangeable lens 100 comprises the lens 101, the lens frame 102, the rectilinear frame 107, the cam frame 108, the index ring 110, the index ring motor 111, a cam driver 300, and a cam frame position sensor (position sensor) 301.

The rectilinear frame 107 has a rectilinear groove (not shown) extending in a direction parallel to the optical axis X direction.

The cam frame 108 has a cam groove, and is disposed on the outer peripheral side of the rectilinear frame 107 so as to be able to rotate around the rectilinear frame 107.

The lens frame 102 has the convex portion 118 that protrudes in a direction perpendicular to the optical axis X. The convex portion 118 mates with the cam groove of the cam frame 108 and the rectilinear groove of the rectilinear frame 107.

The position of the lens frame 102 is determined by the cam groove of the cam frame 108 and the groove of the rectilinear frame 107. That is, when the cam frame 108 rotates, the position where the lens frame 102 is supported on the cam frame 108 changes in the optical axis direction along the rectilinear groove of the rectilinear frame 107.

The cam driver 300 is linked to the cam frame 108. The cam driver 300 may be linked to a manual ring or to a driver having a reduction gear mechanism and an actuator (a stepping motor or a ring-shaped ultrasonic motor).

When the cam frame 108 is rotationally driven by the cam driver 300, the lens frame 102 is driven in the optical axis X direction.

The cam frame position sensor 301 then senses the rotation position of the cam frame 108 that has been rotationally driven. The position of the lens frame 102 is calculated on the basis of the sensed rotation position of the cam frame 108.

The cam frame position sensor 301 may directly sense the physical position of the cam frame 108, or the position of the cam frame 108 may be calculated on the basis of the drive amount of the cam driver 300.

The characteristic computer 113 calculates the subject distance on the basis of the position of the lens frame 102 and other required information (with a zoom lens, this includes focal distance information and the like). The optical characteristic calculated by the characteristic computer 113 is not limited to the subject distance, and may be the focal distance just as in Embodiment 2 above.

The index ring position sensor 114 senses the position of the index ring 110 in its rotation direction.

The drive amount controller 116 calculates the drive amount of the index ring motor 111 on the basis of the calculation result of the characteristic computer 113 and the sensing result of the index ring position sensor 114, and outputs a drive signal corresponding to the calculated drive amount to the index ring motor 111.

As discussed above, the interchangeable lens 100 comprises the cam frame 108, the cam driver 300, the cam frame position sensor 301, the characteristic computer 113, the index ring 110, and the index ring motor 111.

The cam driver 300 moves the cam frame 108 in the rotation direction.

The cam frame position sensor 301 senses the position of the cam frame 108 in its rotation direction.

The characteristic computer 113 calculates the position of the lens frame 102 on the basis of the rotation direction of the cam frame 108 sensed by the cam frame position sensor 301, and computes an optical characteristic on the basis of the position of the lens frame 102 and other necessary information.

The index ring 110 displays the optical characteristic on the display portion 115 on the basis of the drive amount calculated by the characteristic computer 113.

The index ring motor 111 drives the index ring 110 on the basis of the computation result of the characteristic computer 113.

Furthermore, the ratio between the drive amount generated by the cam driver 300 and the drive amount of the index ring motor 111 varies with the position of the cam frame 108.

With the interchangeable lens 100 in this embodiment, this configuration allows the graduation display on the index ring 110 to be set as desired, which means that a lens barrel can be provided that affords greater design latitude than in the past.

### Other Embodiments

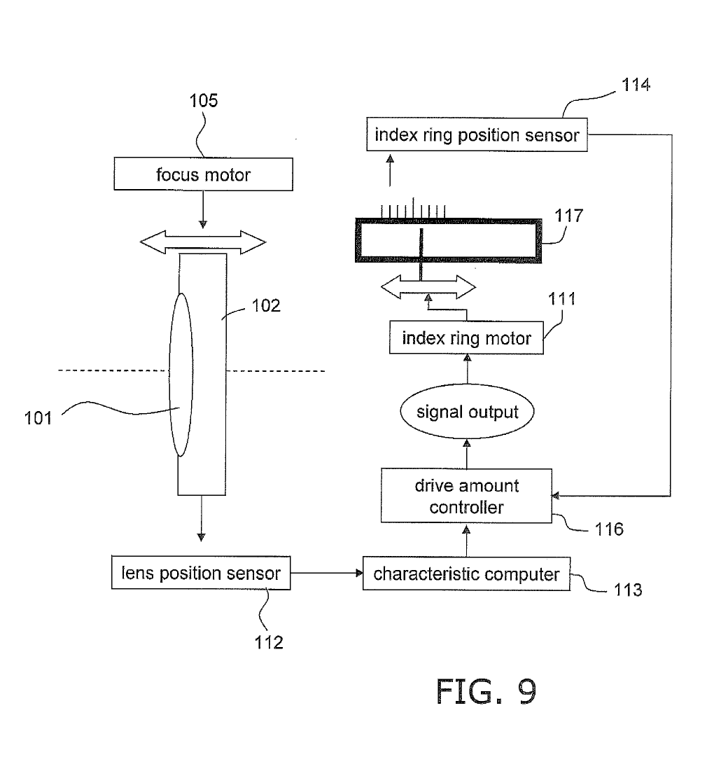

FIG. 9 is a simplified cross section of the configuration of the interchangeable lens in another embodiment.

The interchangeable lens shown in FIG. 9 is different from Embodiment 1 in that the layout direction of the graduations displayed on the index ring 110 extends in a direction parallel to the optical axis direction, but the rest of the configuration is basically the same.

Thus, the mode of an index portion (display portion) 117 of the index ring 110 may be any mode at all, so long as it displays an optical characteristic.

### INDUSTRIAL APPLICABILITY

This disclosure can be applied to an interchangeable lens type of imaging device. More specifically, this disclosure can be applied to an interchangeable lens barrel of an interchangeable lens camera, or the like.

### GENERAL INTERPRETATION OF TERMS

In understanding the scope of the present invention, the term “configured” as used herein to describe a component, section, or a part of a device includes hardware and/or software that is constructed and/or programmed to carry out the desired function.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including,” “having,” and their derivatives. Also, the terms “part,” “section,” “portion,” “member,” or “element” when used in the singular can have the dual meaning of a single part or a plurality of parts.

Terms that are expressed as “means-plus function” in the claims should include any structure that can be utilized to carry out the function of that part of the present invention. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A lens barrel, comprising:
a lens frame that holds a lens;
a first driver configured to move the lens frame in a rectilinear direction;
a position sensor configured to sense the position of the lens frame;
a computer configured to compute an optical characteristic on the basis of the position of the lens frame sensed by the position sensor;
a display portion that displays the optical characteristic; and
a second driver configured to drive the display portion on the basis of the computation result of the computer.

2. The lens barrel according to claim 1,
wherein the ratio between the amount of drive of the first driver and the amount of drive of the second driver varies with the position of the lens frame.

3. A lens barrel, comprising:
a cam frame configured to be rotationally driven to move a lens frame holding a lens, in the optical axis direction;
a first driver configured to move the cam frame in a rotational direction;
a position sensor configured to sense the position of the cam frame in the rotational direction;
a computer configured to compute an optical characteristic on the basis of the position of the cam frame sensed by the position sensor;
a display portion that displays the optical characteristic; and
a second driver configured to drive the display portion on the basis of the computation result of the computer.

4. The lens barrel according to claim 3,
wherein the ratio between the amount of drive of the first driver and the amount of drive of the second driver varies with the position of the cam frame.

5. The lens barrel according to claim 1,
wherein the optical characteristic is the focal distance.

6. The lens barrel according to claim 1,
wherein the optical characteristic is the subject distance.

7. An imaging device, comprising:
the lens barrel according to claim 1; and
a camera body to which the lens barrel is mounted.

8. The lens barrel according to claim 3,
wherein the optical characteristic is the focal distance.

9. The lens barrel according to claim 3,
wherein the optical characteristic is the subject distance.

10. An imaging device, comprising:
the lens barrel according to claim 3; and
a camera body to which the lens barrel is mounted.
